(19) United States
(12) Patent Application Publication
(10) Pub. No.: US 2014/0177964 A1
(43) Pub. Date: Jun. 26, 2014

(54) VIDEO IMAGE SEARCH

(71) Applicant: Unicorn Media, Inc., Tempe, AZ (US)

(72) Inventors: Michael Edmund Godlewski, Mesa, AZ (US); Albert John McGowan, Phoenix, AZ (US); Matthew A. Johnson, Tempe, AZ (US)

(73) Assignee: Unicorn Media, Inc., Tempe, AZ (US)

(21) Appl. No.: 14/192,723

(22) Filed: Feb. 27, 2014

Related U.S. Application Data
(63) Continuation-in-part of application No. 12/549,281, filed on Aug. 27, 2009.
(60) Provisional application No. 61/092,236, filed on Aug. 27, 2008.

(51) Int. Cl. G06K 9/62

(52) U.S. Cl. CPC G06K 9/6202
USPC 382/190

(57) ABSTRACT

Techniques disclosed herein provide for conducting an image search of video frames using a captured image of a display or a screen capture of a media item during playback. Results of the image search may be used to play back a corresponding video from the point in the video at which the captured image was taken, initiate a second-screen user experience, and/or perform other functions. Techniques are also disclosed for building a library of video frames with which image searches may be conducted.

This application is a continuation-in-part of U.S. patent application Ser. No. 12/549,281 filed on Aug. 27, 2009 which claims the benefit of U.S. Provisional Patent Application No. 61/092,236 filed on Aug. 27, 2008, both of which are incorporated by reference herein for all purposes.

### BACKGROUND

There are many disparate methods of accessing a media item such as a TV show or a movie. Some methods include the following: watching a stream directly from a website such a Hulu.com or Youtube; watching a video from a handheld device such as an iPhone® or Windows Media® enabled phone; watching from a device connected to a traditional television in a home such as a computer connected directly to a TV or a device created specifically for delivering video to the TV such as those manufactured by D-Link® or Netgear®; or watching a media item though a service that is delivered to a television directly or through the use of a set top box device. These methods can be accessed via an Internet Protocol (IP), a traditional Over The Air (OTA) or wireless solution, including terrestrial broadcast solutions and solutions known as Wimax or WiFi, Satellite Broadcast (SB), or another wired type solution such as cable television.

### SUMMARY

Techniques disclosed herein provide for conducting an image search of video frames using a captured image of a display or a screen capture of a media item during playback. Results of the image search may be used to play back a corresponding video from the point in the video at which the captured image was taken, initiate a second-screen user experience, and/or perform other functions. Techniques are also disclosed for building a library of video frames with which image searches may be conducted.

An example method of conducting a video image search and providing results thereof, according to the description, includes receiving, via a data communications network interface, an image, extracting one or more of features of the image, generating a representation of the image, based on the one or more features, and comparing, using a processing unit, the generated representation with a plurality of stored representations. The plurality of stored representations includes stored representations of video frames from one or more videos. The method further includes determining a subset of the plurality of stored representations, the subset comprising stored representations with a degree of similarity to the generated representation above a certain threshold, and sending, via the data communications network interface, information regarding the subset of the plurality of stored representations. The information comprises, for each stored representation in the subset, a Universal Resource Locator (URL) related to a video corresponding to the stored representation.

The example method of conducting the video image search and providing the results thereof can include one or more of the following features. For at least one stored representation in the subset, the URL related to the video corresponding to the at least one stored representation can be configured to, when selected using an electronic device, cause the video to be streamed to the electronic device. The URL can be further configured to cause the video to begin the streaming at substantially the same point in the video at which the video frame of the corresponding stored representation appears. The method can further comprise creating the plurality of stored representations by obtaining the video frames from the one or more videos, and, for each video frame, extracting one or more features of the video frame, generating a representation of the video frame, based on the one or more features, and storing the generated representation of the video frame. Obtaining the video frames can occur during a transcoding process of the one or more videos. The one or more videos can be obtained from a web site. The image can be a digital photograph of a display showing a video image; or a screen capture of a displayed image. For at least one stored representation in the subset, the URL related to the video corresponding to the at least one stored representation can be configured to, when selected using an electronic device, cause the electronic device to display a web page having information regarding the video corresponding to the at least one stored representation. The information regarding the video can include metadata received as part of a video ingest process. The method can further include, in the web page, an advertisement based on a key word associated with the video frame of the at least one stored representation. The method can further include ranking each stored representation of the subset of the plurality of stored representations by a likelihood that each stored representation matches the generated representation. The ranking for each stored representation can be based on analytics information of a corresponding video. Determining the subset of the plurality of stored representations can be based on an IP address from which the image is received.

An example server for conducting a video image search and providing results thereof, according to the disclosure, includes a communications interface, a memory, and a processing unit communicatively coupled with the communications interface and the memory. The processing unit is configured to cause the server to receive, via the communications interface, an image extract one or more of features of the image, generate a representation of the image, based on the one or more features, and compare the generated representation with a plurality of stored representations. The plurality of stored representations includes stored representations of video frames from one or more videos. The processing unit is further configured to cause the server to determine a subset of the plurality of stored representations, the subset comprising stored representations with a degree of similarity to the generated representation above a certain threshold, and send, via the communications interface, information regarding the subset of the plurality of stored representations. The information comprises, for each stored representation in the subset, a Universal Resource Locator (URL) related to a video corresponding to the stored representation.

The server for conducting the video image search and providing the results thereof can include one or more of the following features. The processing unit is further configured to cause the server to create the plurality of stored representations by obtaining the video frames from the one or more videos, and, for each video frame, extracting one or more features of the video frame generating a representation of the video frame, based on the one or more features, and storing the generated representation of the video frame.

A non-transitory computer-readable medium, according to the disclosure, has instructions embedded thereon for conducting a video image search and providing results thereof. The instructions include computer code for performing functions including receiving an image, extracting one or more of features of the image, generating a representation of the image, based on the one or more features, and comparing the generated representation with a plurality of stored representations. The plurality of stored representations includes stored representations of video frames from one or more videos. The instructions further include computer code for performing functions including determining a subset of the plurality of stored representations, the subset comprising stored representations with a degree of similarity to the generated representation above a certain threshold, and sending information regarding the subset of the plurality of stored representations. The information comprises, for each stored representation in the subset, a Universal Resource Locator (URL) related to a video corresponding to the stored representation.

The computer-readable medium can include one or more of the following features. The instructions can further include computer code for creating the plurality of stored representations by: obtaining the video frames from the one or more videos, and, for each video frame, extracting one or more features of the video frame, generating a representation of the video frame, based on the one or more features, and storing the generated representation of the video frame. The instructions can further include computer code for creating a web page having information regarding the video corresponding to at least one stored representation of the subset. The computer code for creating the web page can further include computer code for providing, in the web page, an advertisement based on a key word associated with the video frame of the at least one stored representation. The instructions can further include computer code for ranking each stored representation of the subset of the plurality of stored representations by a likelihood that each stored representation matches the generated representation.

Some embodiments of the invention provide a process including a user viewing a media item through at least one of a first device and a second device. The process comprises providing a database that stores the media item in a first format and a second format, the user choosing to view the media item on the first device, and a processing unit determining the first format is necessary to view the media item on the first device. The process also comprises the user pausing the media item on the first device in the first format at a stop time and the processing unit saving the stop time of the media item in the first format and the second format in the database. The process further comprises the user choosing to view the media item on the second device and the processing unit determining the second format is necessary to view the media item on the second device, retrieving the second format from the database, and playing the second format on the second device from the saved stop time.

Some embodiments of the invention provide a system for a user to view a media file through at least one of a first device and a second device. The system comprises a database that stores the media file in a first format and a second format and a processing unit that determines which of the first format and the second format is necessary to view the media file on at least one of the first device and the second device. The system further comprises a system memory for saving a stop time of the media file in the first format and the second format in the database such that the media file can be resumed at the stop time in one of the first format on the first device and the second format on the second device.

### DESCRIPTION OF THE DRAWINGS

FIG. 1 is a perspective view of a system that can allow playback of media items on various devices, according to one embodiment of the invention.

FIG. 2 is a block diagram illustrating an embodiment of a media servicing system, which can utilize the video playback and/or image searching techniques discussed herein.

FIG. 3 is an illustration showing an embodiment of how video playback and/or a second-screen experience on a second device can be initiated from an image capture of a first device.

FIG. 4 is a simplified swim-lane diagram of this general process, according to one embodiment.

FIG. 5 is a block diagram illustrating a method of conducting a video image search, according to one embodiment.

FIG. 6 is a flow diagram of a method of processing and storing representations of video frames, according to one embodiment.

FIG. 7 illustrates an embodiment of a computer system, which may be configured to execute various functions described herein.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

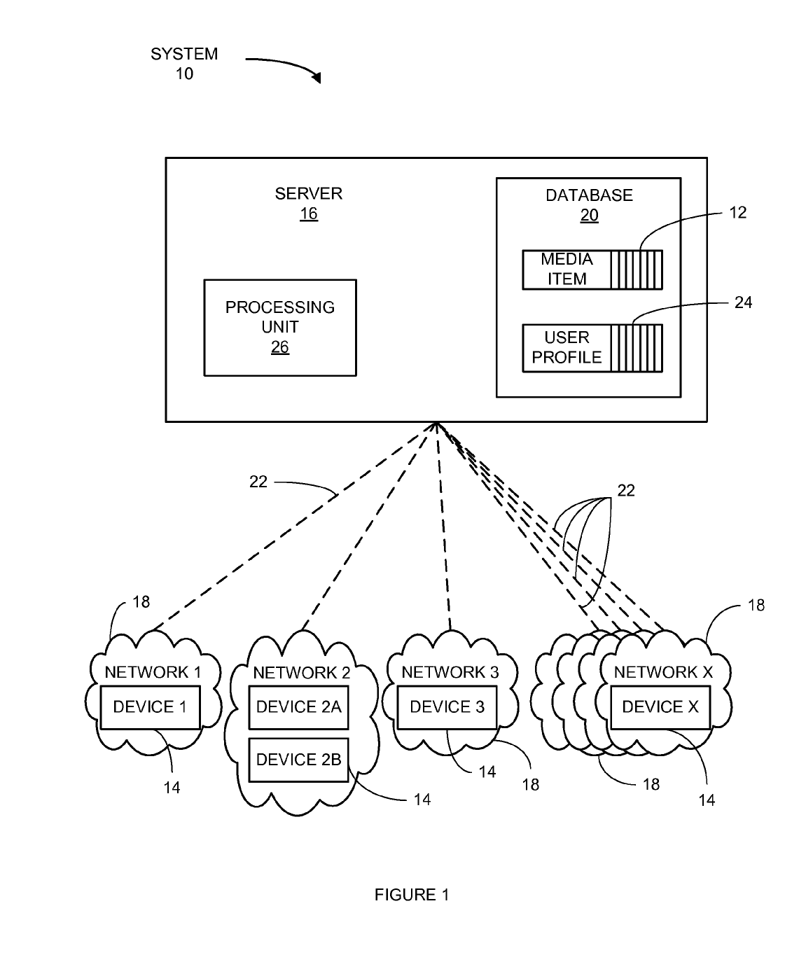

FIG. 1 illustrates a system 10 according to one embodiment of the invention. The system 10 can provide media items 12, such as videos of movies or television shows, for a user to view. The system 10 can have the ability to pause and resume a media item 12 across multiple disparate platforms and devices 14. Specifically, the system 10 can allow the user to pause a media item 12 while watching it on one device 14 and resume the media item 12 on a different device 14 at the same location in the media item 12, regardless of the file format required for the media item 12 to be viewed on the device 14.

The system 10 can include a server 16 in communication with devices 14 on one or more networks 18. The server 16 can also include at least one database 20. The database 20 can store a plurality of media items 12 in various formats (e.g., Flash, Quicktime, Windows Media files, etc.). Specifically, the same media item 12 (i.e., a particular movie) can be stored in the database 20 in more than one format.

The user can log into the system 10 through a device 14 connected to the server 16 via network connections 22. In some embodiments, examples of devices 14 can include, but are not limited to, a smartphone (such as an iPhone, Blackberry, or a Palm Pre), a television set in connection with a set top box device (e.g., TiVo®) or a home network (e.g., through D-Link® or Netgear®), and a computer in connection with a video viewing website (such as Netflix®).

An example of a network 18 can include the internet. Another example of a network 18 for devices 14 such as smartphones can be a 3G network. Some examples of network connections 22 can include traditional Over The Air (OTA) or wireless connections, including terrestrial broadcast solutions and solutions known as Wimax or WiFi, Satellite Broadcast (SB), or another wired type solution such as cable television.

The user can have an account with the system 10 in order to search and view media files 12. The system 10 can then store a user profile 24 including user account information such as log in information, user information, user viewing history information, user search history, etc. in the database 20. The user viewing history information can include resume records of various media items, as described below.

Once logged into the system 10, the user can search the database 20 for specific media items 12 to view. The user can then choose to view a first media item 12 on their device 14. The user can have the options to play, pause, fast forward, and rewind the first media item 12, similar to a videocassette player or digital video recorder system. However, if the user pauses the first media item 12, the system 10 can present a “resume later” option. If the resume later option is selected, the server 16 can record information about the first media item 12 and the user in the database 20. For example, some information can include the name of the first media item 12, a timestamp of when the first media item 12 was paused (i.e., the resume point) and/or a screenshot of the time-stamped resume point in the first media item 12. Such information can be considered the resume record for the media item 12 and can be recorded in a system memory (not shown) under the user profile 24. The resume record can be determined and recorded by a processing unit 26 on the server 16. In some embodiments, the system memory can be the database 20.

In addition to recording the resume point in the first media item 12 viewed, the system 10 can also recall all file formats of the first media item 12 stored in the database 20, and save resume points for each different file format under the resume record. In one embodiment, the system 10 can determine the resume points in different file formats using the elapsed time to the resume point in the first file format originally viewed.

In some embodiments, the resume record will not include the device 14 that the media item 12 was played on or the specific format the media item 12 was played with since that data may not be relevant to the later resumption of the media item 12. Instead, the resume record can simply include the resume point in all file formats. Further, the resume record does not have to include each entire file of the media item 12 in the user profile 24. Rather, only the name of the media item 12 and the resume point in all file formats can be necessary. This can allow the database 20 to only require one file for each format of a media item 12 in a common space, instead of multiple user profiles 24 in the database 20 having the same file, which greatly conserves storage space in the database 20.

After the information is recorded, the user can further search for more media items 12 or log out of the system 10. If the user chooses to view a second media item 12, the recorded information about the first media item 12 can still be saved in the database 20 and will not be affected. In addition, the user can pause the second media item 12, choose the resume later option, and information about the second media item 12 can be recorded in the database 20 without affecting the information recorded about the first media item 12. The user can then further search for more media items 12 or log out of the system 10. The user can also go back to the first media item 12 and resume viewing the first media item 12 from its paused position or from the beginning.

When the user logs out of the system 10, the user's resume records can still be saved in the database 20 under their user profile 24. Therefore, when the user logs back into the system 10, the user has the ability to view the saved media items 12 from their respective resume points. Because the system 10 recorded the resume point for the media item 12 in all file formats, the user is able to log into the system 10 using a second device 14 (e.g., device 3 in FIG. 1) with a different operating system 10 than a first device 14 (e.g., device 1 in FIG. 1) and still view the media item 12 from the resume point regardless of the file format required.

The system 10 can be used with virtually any device 14 that supports streaming video and can be connected to a network 18. In order to determine which file format is compatible with the device 14 being used, the processing unit 26 on the server 16 can perform a speed test (e.g., a bandwidth speed test) to determine the type of device 14 and an appropriate bandwidth the device 14 is capable of using. From this determination, the processing unit 26 can communicate with the database 20 to locate and restore the appropriate video format for viewing the media item 12.

The following paragraphs illustrate a first example use of the system 10 according to one embodiment of the invention.

A user logs into the system 10 via a web site while using their computer at work. The user selects a video (i.e., the media item 12) to watch and the system 10 (e.g., the processing unit of the system 10) uses a speed test to check the bandwidth and the type of device 14 the user is connecting from (i.e., the computer). The system 10 then selects the appropriate video format and bitrate to deliver the highest possible watching experience for the user. In this case, it is a Flash Video format at 1 megabit per second (Mbps) since, for example, the bandwidth is limited in the office. The media item 12 can then be played at the equivalent of 720p (a middle quality high definition, or HD, resolution).

The user then pauses the media item 12 and logs off the system 10. The system 10 stores the resume record of the media item 12 in the database 20. At this time the system 10 determines the resume point in all the various video file formats available for the media item 12 in the database 20. All of the resume points are stored within the resume record under the user's user profile 24 in the database 20 for future use.

The user travels home on a bus from work and logs back into the system 10 on their iPhone®, for example, using an iPhone application for the system 10. The system 10 determines the user is on an iPhone® based on the information gleaned from the user logging in with the iPhone application. The user selects to resume the media item 12 they were previously watching. In this case, the iPhone can support a Quicktime video format, but using a variable bitrate version since the user is connected via a 3G network whose bandwidth may ebb and flow and therefore support anything from 480p to 1080p (Low HD to High HD). Since the system 10 has already determined the resume point of the media item 12 in those file formats prior to the user requesting it, the playback of the media item 12 at the resume point can be nearly instantaneous. The system 10 therefore chooses the Quicktime formatted version of the media item 12, selects the variable bitrate, and resumes the media item 12 for the user to view on their device 14.

The user arrives at his bus stop and again pauses the media item 12. The system 10 can again record the resume point for the media item 12 and creates a new resume record. The new resume record, as well as the old resume record, for the media item 12 can be saved in the database 20 under the user's profile 24. The user then logs out of the system 10.

The user returns home and turns on their television that has a TiVo device connected to it. The TiVo device 14 can be connected to the system 10 via a network connection 22. Therefore, the user can log into the system 10 from their TiVo device and select to resume the media item 12. The system 10 determines the user has signed in through the TiVo device and the large amount of broadband bandwidth available and therefore selects a full h.264 MPG2 version of the media item at 15 Mbps (Full 1080p HD with 5.1 or 7.1 audio) and resumes the playback at the resume point. Since the system 10 had already determined the resume point of the media item 12 in that file format prior to the user requesting it, the playback of the media item 12 can be near instantaneous.

The following paragraphs illustrate a second example use of the system 10 according to one embodiment of the invention.

A user begins watching a two hour long media item 12 on their computer at their office. They are using a desktop computer utilizing Flash technology. The media item 12 is a long form video and the individual does not have enough time to finish watching the media item 12. The individual selects the pause button in the Flash media player and is presented with the resume later option. Once selected, the system 10 stores the resume record, the individual logs out of the system 10 and travels to the train station to return home.

On the way, the user logs back into the system 10 on their Blackberry™ equipped with Windows Media Player. The user selects the media item 12 for resumption and the system 10 recognizes the media item 12 should be delivered in WMA format instead of Flash based on the new device 14 (i.e., the Blackberry™). The system 10 draws the WMA file from the database 20 and navigates to the resume point as saved in the resume record. The system 10 then resumes playback of the media item 12 at the resume point.

At the end of the user's commute on the train, the media item 12 has still not finished so the user repeats the process of pausing the media item and having a resume record saved in the database 20 under the user's profile 24. Both the newly created resume record and the previous resume record can be stored in the database 20.

Upon arriving at home, the user logs back into the system 10 via their Windows Media Center PC connected to their television. Navigating the system 10, the individual again selects to resume the media item 12 they were watching and the system 10 delivers the media item 12 from the resume point in WMA format.

In another embodiment of the invention, the resume record can include a snapshot view of the media item 12 at the resume point. When the system 10 retrieves the media item 12, the system 10 can use the snapshot in addition to, or rather than, the recorded time elapsed to ensure the resume point is correct. The system 10 can match an exact frame in the media item 12 to the snapshot previously saved, regardless of the formats used in the current or previous sessions. This can be helpful when different file formats are encoded slightly different and resuming at a time elapsed resume point may present different points in the media item 12 across different file formats.

According to another embodiment of the invention, a resume record can be established even when the media item 12 was not viewed on the system 10. This embodiment can utilize the frame matching technique described above. The following paragraphs illustrate an example use of the system 10 according to this embodiment of the invention.

A user can watch a media item 12 at a public gathering place or other such location in a manner that they are not logged into the system 10. The user must leave the viewing of the media item 12 prior to its completion. The user has a digital camera available for use and takes a picture of the image on the screen. Once the user comes to a location that has access to the system 10 (e.g., via a network 18), they can log into the system 10 and upload the image from the media item 12. The system 10 can then use the snapshot to search frames of media items 12 in the database 20 to find the exact media item 12.

In addition, media items 12 in the system 10 can include peripheral information (in text form). Therefore, the user can include the title of the media item 12, if known. If not known, a partial title, specific actor, director or any other peripheral information that can be entered into the system 10 to narrow down the media item 12 being searched for can be loaded.

If the exact title is known, the system 10 can retrieve the media item 12 from the database 20. If the exact title is not known, the system 10 can incorporate all the peripheral information entered by the user and perform a search. More peripheral information entered can make it easier for the system 10 to find the media item 12, and therefore can substantially reduce the search time needed.

Once the system 10 finds the correct media item 12, it can use a visual search algorithm, such as the visual search method developed by Google®, to locate the exact location of the image within the media item 12. Once located, the system 10 can launch the media item 12 at the exact location of the captured image and the individual can resume their viewing experience.

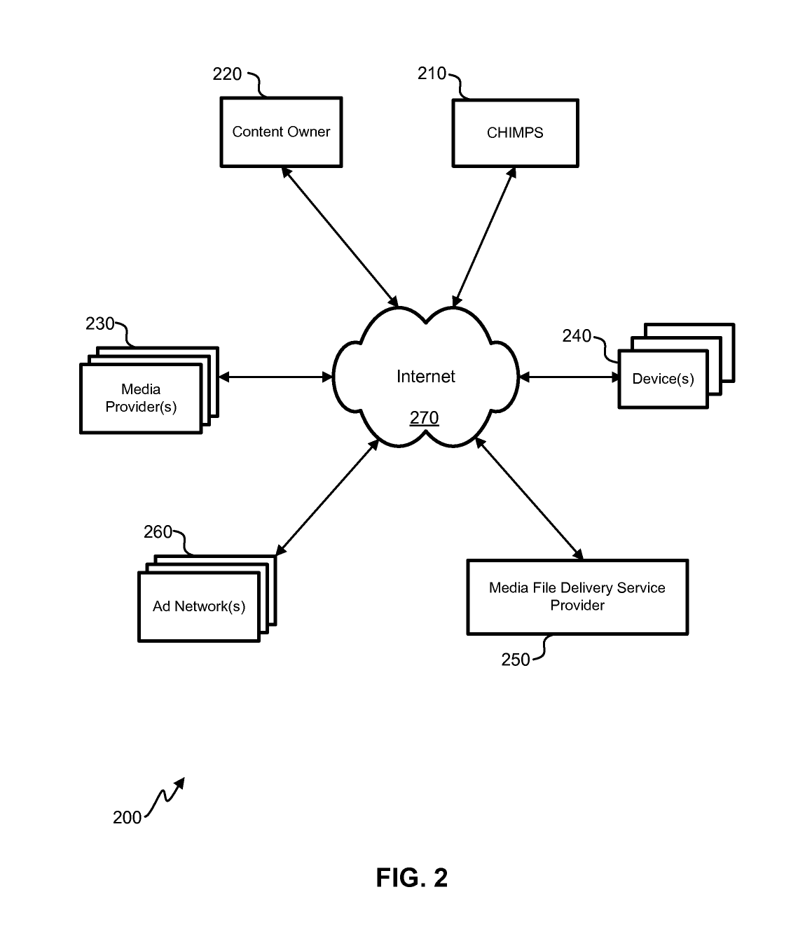

FIG. 2 is a block diagram illustrating an embodiment of a media servicing system 200, which can utilize the video playback and/or image searching techniques discussed herein. It will be understood, however, that the media servicing system 200 is provided only as an example system utilizing such techniques. A person having ordinary skill in the art will recognize that the video playback and/or image searching techniques provided herein can be utilized in any of a wide variety of additional applications.

The illustrated media servicing system 200 may deliver media content to device(s) 240, such as the devices illustrated in FIG. 2 via, for example, a media player, browser, or other application adapted to request and/or play media files. The media content can be provided via a network such as the Internet 270 and/or other data communications networks, such as a distribution network for television content, a cellular telephone network, and the like. As detailed above, device(s) 240 can be one of any number of devices configured to receive media over the Internet 270, such as a mobile phone, tablet, personal computer, portable media device, set-top box, video game system, etc. Although few device(s) 240 are shown in FIG. 2, it will be understood that the media servicing system 200 can provide media to many (hundreds, thousands, millions, etc.) of device(s) 240.

Media content provided by one or more media providers 230 can be ingested, transcoded, and indexed by cloud-hosted integrated multi-node pipelining system (CHIMPS) 210, and ultimately stored on media file delivery service provider (MFDSP) 250, such as a content delivery network, media streaming service provider, cloud data services provider, or other third-party media file delivery service provider. (Additionally or alternatively, the CHIMPS 210 may also be adapted to store the media content.) Accordingly, the CHIMPS 210 and/or the MFDSP 250 of FIG. 2 can comprise the server 16 and/or database 20 of FIG. 1. The content (both live and on-demand) can utilize any of a variety of forms of streaming media, such as chunk-based media streaming in which a media file or live stream is processed, stored, and served in small segments, or “chunks.” Additional detail regarding techniques, can be found in U.S. Pat. No. 8,327,013 entitled “Dynamic Index File Creation for Media Streaming” and U.S. Pat. No. 8,145,782, entitled “Dynamic Chunking For Media Streaming,” both of which are incorporated by reference herein in their entirety.

A content owner 220 can utilize one or more media provider(s) 230 to distribute media content owned by the content owner 220. For example, a content owner 220 could be a movie studio that licenses distribution of certain media through various media providers 230 such as television networks, Internet media streaming websites and other on-demand media providers, media conglomerates, and the like. In some configurations, the content owner 220 also can operate as a media provider 230. The content owner 220 and/or media provider(s) 230 can further enter into an agreement with one or more ad network(s) 260 to provide advertisements for ad-supported media streaming.

Techniques for media playback described in relation to FIG. 1 can further apply to systems such as the CHIMPS 210, MFDSP 250, ad network(s) 260, and the like, which can employ a plurality of computers to provide services such as media ingesting, transcoding, storage, delivery, etc. Because the media servicing system 200 can involve transcoding and storing a vast amount of media, it includes the resources to create a database of searchable video frames as discussed above with relative ease, which can provide playback functionality described above, as well as a rich second-screen experience for users as described in further detail below.

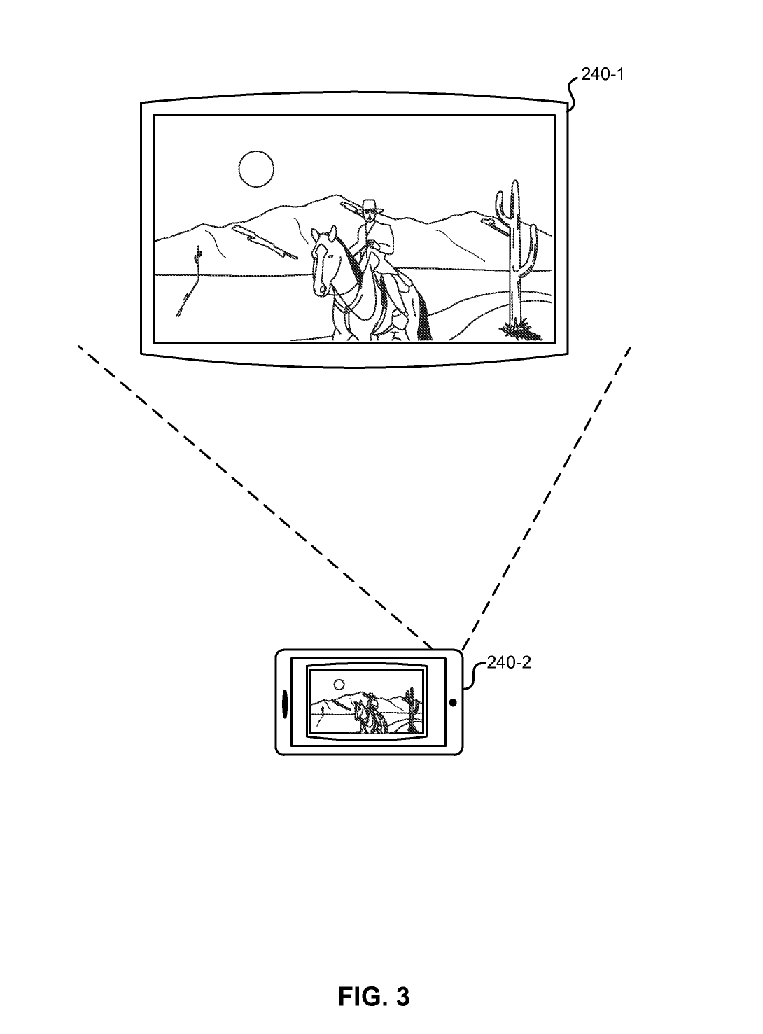

FIG. 3 is an illustration showing an embodiment of how video playback on a second device and/or a second-screen experience can be initiated. Here, video may be playing back on a first device 240-1. A second device 240-2 configured with a camera, such as a mobile phone, personal media player, and the like, may include an application by which a user may capture an image (and/or use a previously-captured image) of video playback on the first device. The image may then be sent to a server (such as the server 16 of FIG. 1) which can determine a list of likely video frames corresponding to the image and return the list of results to the second device 240-2. The user can then select the best result, and the server can send additional information regarding the selection, providing any of a variety of functions to a user.

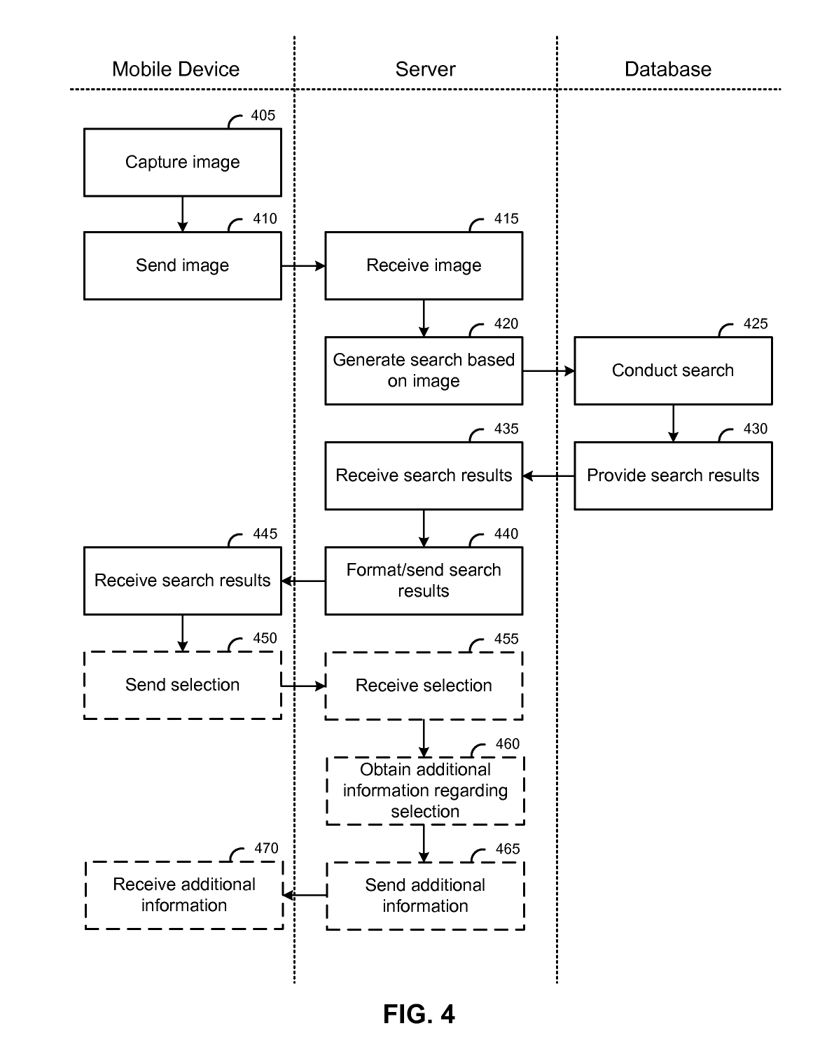

FIG. 4 is a simplified swim-lane diagram of this general process, according to one embodiment. Here, a mobile device acts as a second device that captures an image, or digital photograph, of a first device on which media is played back.

At block 405, the mobile device captures an image of the display of a first device as the first device plays back a media item such as a movie, television show, advertisement, and the like. Some media, such as advertisements, may prompt a user to capture an image to obtain more information (e.g., about an advertised product or service). Additionally or alternatively, there may simply be an icon or other indication in the media (as it is played back on a first device), indicating that additional information regarding the media is available.

The image may be captured using a specialized application executed by the mobile device. The application may, among other things, automate one or more of the functions of the mobile device as illustrated in FIG. 4. Additionally or alternatively, the mobile device may capture an image via a standard image-capture application, and later select the captured image using a specialized application and/or web page. In alternative embodiments, the mobile device may be able to obtain an image via alternative means, such as downloading it or otherwise receiving it from a source other than an integrated camera. At block 410, the image is sent to the server. The server may employ an Application Programming Interface (API) to interact with the mobile device.

At block 415, the image is received at the server. The image is then used to generate a search at block 420. As previously indicated, standard image algorithms may be utilized to generate and conduct the search, which is conducted by the database at block 425. Additional information regarding this function of the server is provided below.

As a result of the search, the database provides a list of search results at block 430. The search results can include, for example, a list of video frames corresponding to likely matches to the image of the media captured by the mobile device at block 405. The search results may include a video frames from a single media item and/or video frames from multiple media items. Some embodiments may provide a number of the top search results (e.g., the top 5, 10, 20, etc. results) based on the degree of similarity with the captured image, as determined by the search algorithm. Some embodiments may provide all search results having a degree of similarity with the captured image above a certain threshold (again, as determined by the search algorithm).

The search results are then received by the server at block 435, which then formats and sends the search results to the mobile device at block 440, which are received by the mobile device at block 445. Formatting the search results may include further refining and/or filtering the search results based, for example, on user preferences. The search results may include information for each result including a title of a corresponding media item, a time within the media item to which the result corresponds, an image of the video frame corresponding to the result, and the like. Additionally or alternatively, the server may format the search results by providing a list of search results, each result having a corresponding Universal Resource Locator (URL). Depending on desired functionality, the URL may be embedded in the search results, allowing a user to select a result from the list of search results. Upon selection, any of a variety of actions may take place, depending on desired functionality.

In one embodiment, as described above, the URL may cause the corresponding media item to be streamed to the mobile device, beginning at or near the video frame corresponding to the selected result. In an example using the components of FIG. 2, the URL of the selected result may cause the mobile device (which could correspond to one of the device(s) 240) to request from the CHIMPS 210 of FIG. 2 a corresponding media item at a certain point in playback. The CHIMPS 210 may then return an index file allowing the mobile device to stream the media item from the MFDSP 250 using a chunking protocol, starting at the certain point in playback. Thus, a user would be able to use the mobile device to capture an image of a movie played back on a computer, TV, or other display, receive a list of possible results, and, after selecting the correct result from the results list, continue playback of the movie on the mobile device at substantially the same point in the movie at which the captured image was taken.

Some embodiments may provide additional or alternative functionality. Such functionality may include further interaction between the mobile device and server, as illustrated by optional blocks 450-470. For example, at block 450, the mobile device may send an indication of the selection to the server, which is received at block 455. The server can then obtain additional information about the selection at block 460, and send the additional information to the mobile device at block 465, which is received by the mobile device at block 470.

The additional information can enable the mobile device to perform a variety of different functions, including providing a rich second-screen experience to a user. For example, a user may capture an image of an advertisement for a service or product for which the user would like to obtain information. (As previously indicated, the advertisement may prompt the user to capture the image using, for example, a specialized application.) Once the user confirms the correct result and the mobile device sends the user's selection (at block 450), the server can provide additional information, such as a link to a web site for the product or service, a more detailed video about the product or service, a list of local stores and/or service providers with the product or service, and the like.

For movies, television shows, and/or similar media, the additional information provided by the server can include information such as biographical information of the actors, information regarding the scene and/or location, and/or information regarding other items in the captured image. In some embodiments, facial recognition algorithms may be used (e.g., instead of metadata) to identify one or more actors in a video frame and/or captured image. Alternatively, the additional information may include a link to a web page with this information. For example, embodiments may allow a user to use a mobile device to capture an image of a television show playing on a television. After a user confirms the correct result from the search results, a browser of the mobile device may be used to access a web page with additional information regarding that television show and/or that particular part of the television show.

The web page with additional information can include a variety of information, depending on desired functionality. For example, the web page could include an image of the corresponding video frame of the result. Where playback of the media item is available, the image may also include a “play” icon, indicating the media item is available for streaming. Additionally or alternatively, there may be icons superimposed on the image, corresponding to different displayed items (e.g., actors, props, locational features, etc.), which, when selected, can provide additional information regarding the displayed items. The web page may additionally or alternatively include links to other web pages associated with the media item, actors, props, location, etc., such as fan pages, movie web sites, movie databases, related advertisements, and the like. The web page may be dynamically created upon receiving a selection from the search results. Where an advertisement or a link to an advertisement is provided on the web page, creating the web page may further involve contacting one or more ad servers or networks (e.g., ad network(s) 260 of FIG. 2). The advertisement may be based on one or more key words associated with the selected video frame.

This second screen experience can further allow advertisers to promote products that appear in movies and television shows, furthering product placement efforts of advertisers. For example, embodiments may allow a user to use a mobile device to capture an image of a scene in a television show that features a car for which a user would like additional information. After confirming the correct result from a list of search results, the mobile device can then provide the user with a web page of the car, a video advertisement for the car, and/or other information regarding the car. (Additionally or alternatively, the mobile device may first provide a list of selectable items in the television scene for which a user may seek additional information. For example, here, the car may be one of several items for which a user may be provided additional information.) As provided in more detail below, media providers may provide metadata to accompany a media item, allowing particular information (e.g., information about a car) to be associated with particular portions of the media item (e.g., scenes in a television show).

The ability to link advertisements to scenes in media in this manner may allow for additional advertisement opportunities. In the previous example involving the car, for example, metadata associated with the television scene may simply indicate that a “car” or “vehicle” is associated with the scene. This can allow auto manufacturers to purchase advertisements associated with the television scene, such that advertisements for their vehicles (and not necessarily the vehicle shown in the television scene) are provided to a user if the user captures an image of the television scene in the manner described above. Thus, a variety of products or services related to a media item may be advertised to a user when the user captures an image using a mobile device.

Although the embodiment shown in FIG. 4 involves a mobile device, other embodiment may include other devices. In fact, embodiments may involve the playback device so that there is no need to capture an image of a first device with a second device. For example, a set-top box of a television may be configured to take a screen capture of an image displayed on a television and initiate a process similar to the process shown in FIG. 4, where the set-top box is used instead of a mobile device. The capture of the image displayed on the television may be triggered by a user pressing a button on a remote control.

It can be further noted that FIG. 4, as with other figures provided herein, provides a non-limiting example of an embodiment. Other embodiments may add, omit, rearrange, and/or otherwise alter the blocks shown in FIG. 4. For example, a search may return a single result, in which case there may be no need to send search results to or receive a selection from the mobile device. The functionality (e.g., media playback, providing additional information, etc.) in such a case may be initiated automatically after the search. A person of ordinary skill in the art will recognize many additional and/or alternative variations from the embodiment shown.

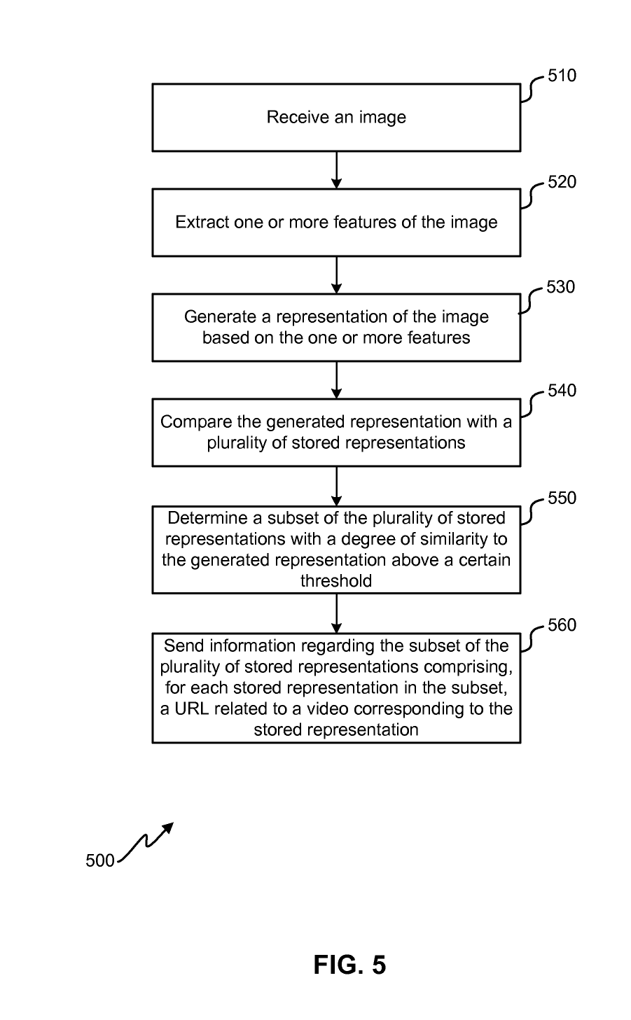

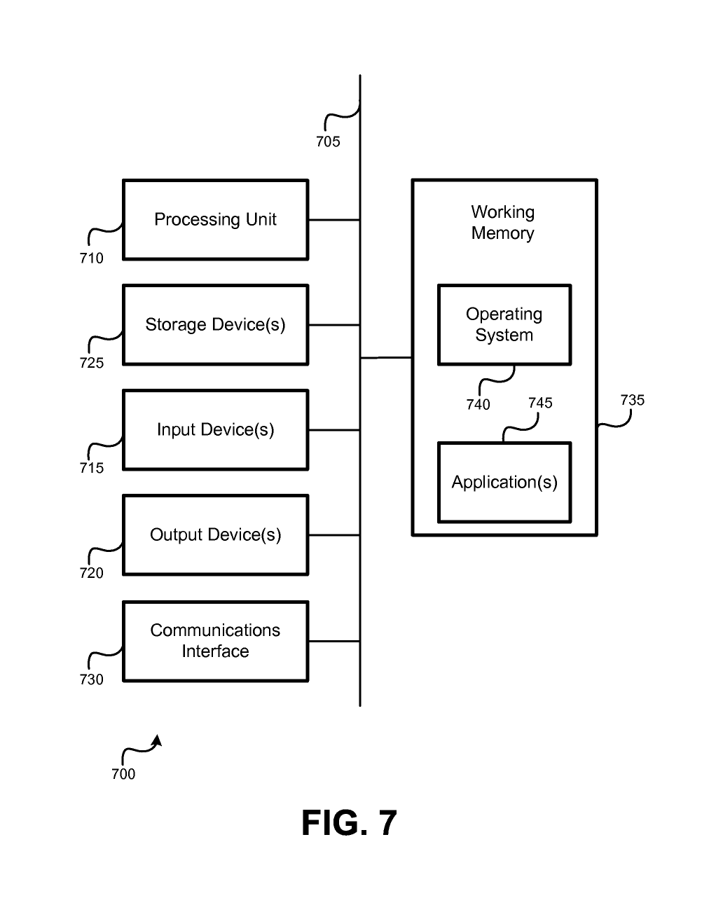

FIG. 5 is a block diagram illustrating a method 500 of conducting a video image search, according to one embodiment. The method 500 can be executed by, for example, the server described in FIGS. 1, and 4. Such a server can be executed in hardware and/or software, including the computer system described below in regards to FIG. 7. Additionally or alternatively components of the method may be executed by different systems, including a mobile device, database, and/or other system as described previously herein. Furthermore, components of the method 500 may be executed in a different order, omitted, added, and/or otherwise altered in alternative embodiments. A person of ordinary skill in the art will recognize many variations to the embodiment illustrated in FIG. 5.

At block 510 an image is received. As described above, the image may be a screen capture of a movie or other media item, or an image of a display of a media item during playback (or pause) of the media item. The image may be captured by a mobile device and received by a server via a data communications network, such as the Internet.

At block 510, one or more features of the image are extracted. Extracted features can vary, depending on desired functionality and image processing algorithms used. Generally speaking, features can include edges, corners, shapes, and/or other recognizable aspects of an image, as well as corresponding traits such as location and scale.

At block 530, a representation of the image based on the one or more features is generated. In other words, features of the image are described using descriptors (comprising text and/or other characters), effectively translating the image from visual to textual representation. In some embodiments, the descriptors can then be matched against a vector-quantized “dictionary” of potential image appearances, creating a frequency map representing the image.

At block 540 the generated representation is compared with a plurality of stored representations. The plurality of stored representations can include, as described above, a plurality of video frames from a library of media items. The video frames can be represented using the same descriptors as used in generating the representation of the received image. As such, the descriptors (or corresponding frequency maps) can be compared to determine a degree of similarity between the generated representation and the stored representation. This can allow the server to, at block 550, determine a subset of the plurality of stored representations with a degree of similarity to the generated representation above a certain threshold.

The stored representations of the subset can be ranked. In some embodiments, a stored representation's ranking may be based on its degree of similarity with the generated representation. Additionally or alternatively, analytics data may be used in the ranking of the results of the subset, where analytical data is available. For example, a server may determine a date/time at which the search request is made and/or when the image was captured, check analytical data of videos being watched at that time, and weight the data accordingly when determining the rankings (That is, highly popular videos at the time of the request or image capture would tend to be ranked higher than less popular videos.) Additionally or alternatively, search results may be ranked based on prior searches and/or selections associated with an IP address of the mobile device or other device requesting the video image search.

In some embodiments, this subset can be further subject to affine verification. That is, the affine transform between the captured image and a stored video frame can be determined. The affine transformation information can then be used to re-rank the results. Some embodiments may further expand a query set by on back-projecting results of the affine verification into the scene, and conduct another search of video frames to potentially obtain additional potential matches. In some embodiments, the affine verification and/or back-projection of results can be used to determine the subset of block 550.

At block 560, information regarding the subset of the plurality of stored representations is sent (e.g., to a mobile device), where, for each stored representation in the subset, the information can comprise a URL related to a video corresponding to the stored representation. For example, as previously described, search results can be provided to the mobile device, where each result includes a URL that allows a user to watch a video corresponding to the result and/or obtain additional information related to the corresponding video. Where a list of search results includes a plurality of media items and more than one potential starting point within at least one of the media items, the search result may be nested, grouping all potential starting points for each media item together.

The functionality of the URL may vary between results. For example, a media servicing system may find a result corresponding with a video for which it does not have the rights or ability to distribute. In alternative embodiments, the method 500 may include an additional component of determining whether a media servicing system has a current license to stream a video to a device, and/or whether a user of a device has a subscription to a service (e.g., Netflix®, HBO®, etc.) that grants such rights. This may involve interfacing with other systems to make the determination. Where it is determined that a media servicing system cannot distribute a video corresponding to a search result, a URL associated with the search result may provide a link to a web page that would allow a user to purchase a subscription and/or otherwise gain access to watch the corresponding video.

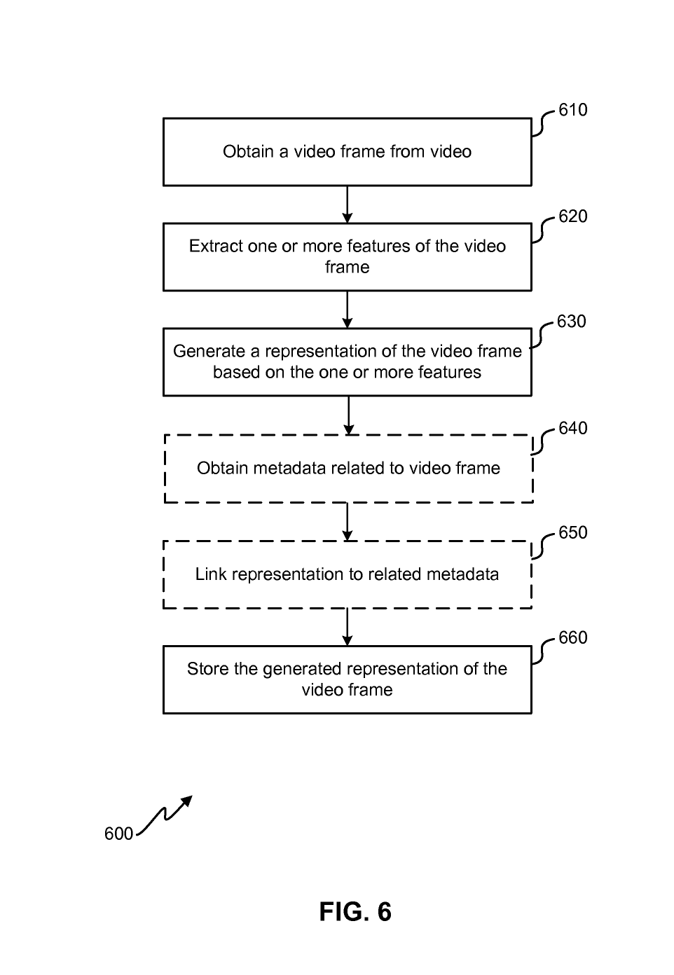

Because media servicing systems (such as the media servicing system 200 of FIG. 2) are typically configured to ingest, transcode, and distribute media items such as video, they are conveniently leveraged to build a database of stored representations of video frames. FIG. 6 is a flow diagram of a method 600 of processing and storing representations of video frames, according to one embodiment, which can be executed by a one or more components of media servicing system (such as the CHIMPS 210 of FIG. 2).

That said, although the method 600 can be performed by a media servicing system, embodiments are not so limited. Some embodiments, for example, may include systems configured to perform some or all of the components of the method 600 that are not configured to distribute the media items at all. Systems may be utilized to create a database of representations and/or conduct video searches without further distributing the corresponding videos, but may be configured work in conjunction with other systems that do so by providing URLs and/or other information for the other systems. For example, a transcoding system may create a database of video information from videos obtained from a separate website. When a video image search is conducted and results from the separate website are obtained, the search results could include links to the separate website for playback of the corresponding video. Additionally or alternatively, the method 600 of FIG. 6 can be independent of a transcode process, and may note involve storing video from which video frames are obtained

As with the method 500 of FIG. 5, the method 600 of FIG. 6 can be executed by, for example, the server described in FIGS. 1, and 4 and/or the computer system of FIG. 7. Additionally or alternatively, components of the method may be executed by different systems, including a mobile device, database, and/or other system as described previously herein. Furthermore, components of the method 600 may be executed in a different order, omitted, added, and/or otherwise altered in alternative embodiments. A person of ordinary skill in the art will recognize many variations to the embodiment illustrated in FIG. 6.

At block 610, a video frame is obtained from a video. This (and other components of the method 600) may be performed while the video is being transcoded. Although each frame of the video may be obtained, the method 600 can be more selective. For example, only certain frames, such as key frames, may be utilized in the method 600. Other embodiments may use other techniques for selectively obtaining video frames, such as obtaining a video frame for every second (3 seconds, 5 seconds, 10 seconds, etc.) of video, or obtaining a frame for every 30 (60, 100, 320, etc.) frames of video.

At block 620, one or more features of the video frame obtained at block 610 are extracted. And at block 630, a representation of the video frame based on the one or more features is generated. In general, the algorithms utilized to perform the functions at 620 and 630 can echo the algorithms described with respect to similar blocks 520 and 530 of FIG. 5. Here, however, because the video frames are not subject to many issues that arise from a captured image (due to, for example, perspective, scaling, lighting/reflection issues, color variations, etc.), the algorithms of blocks 620 and 630 may be streamlined accordingly, if algorithms allow. This can reduce the resource requirements of performing the method 600, which can desirable during processing-heavy functions such as transcoding.

At block 640, metadata related to the video frame can optionally be obtained. For a media servicing system that ingests videos for transcoding, obtaining related metadata (such as title, length, genre, ad break information, etc.) from the media provider may already be part of the video ingest process. Techniques herein further contemplate obtaining additional metadata from the media provider (or another entity) that can be used to determine second screen and/or other additional information related to a media item and/or portions thereof. Depending on desired functionality, obtaining the additional metadata can be part of the video ingest process or provided through a separate process.

Thus, a media provider (or other entity) can provide information to a media servicing system, indicating which metadata belongs to which segments of video. For example, a media provider may supply the media servicing system with information based on timestamps of the video by indicating that a first set of metadata corresponds with time A to time B of the video playback, a second set of metadata corresponds with time B to time C of the video playback, and so forth. Furthermore, as indicated herein above, the metadata may provide specific information (e.g., information regarding a specific car featured in a video) and/or a broad key word or tag (e.g., “vehicle, “car,” etc.), allowing advertisers to advertise products and/or services based on the key word or tag.

Where metadata related to the video frame is obtained at block 640, it can then be linked to the generated representation of the video frame at block 650. And at block 660, the generated representation of the video frame, and the linked metadata (if any), are stored. Depending on desired functionality, representations can be indexed and/or otherwise stored in a manner that facilitates quick access and comparison to perform the image searches discussed herein. Moreover, the representation and metadata can be stored in a database, as shown in FIGS. 1 and 4.

FIG. 7 illustrates an embodiment of a computer system 700, which may be configured to execute various components described herein using any combination of hardware and/or software. For example, one or more computer systems 700 can be configured to execute the functionality of the server and/or device(s) as described above in relation to FIGS. 1-4. Accordingly, one or more components described in relation to FIG. 7 may correspond to components described in previous figures. (For example, the processing unit 710 of FIG. 7 may correspond with the processing unit 26 of FIG. 1.) One or more computer systems 700 may additionally or alternatively be used to implement the functionality of the methods described in relation to FIGS. 5 and 6. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. In addition, it can be noted that components illustrated by FIG. 7 can be localized to a single device and/or distributed among various networked devices, which may be disposed at different physical locations.

The computer system 700 is shown comprising hardware elements that can be electrically coupled via a bus 705 (or may otherwise be in communication, as appropriate). The hardware elements may include processing unit(s) 710, which can include without limitation one or more general-purpose processors, one or more special-purpose processors (such as digital signal processors, graphics acceleration processors, application-specific integrated circuits (ASICs), system on a chip (SoC), and/or the like), and/or other processing structures. The processing unit(s) 710 can be configured to perform one or more of the methods described herein, including the methods described in relation to FIGS. 5 and 6 by, for example, executing commands stored in a memory. The computer system 700 also can include one or more input devices 715, which can include without limitation a mouse, a keyboard, and/or the like; and one or more output devices 720, which can include without limitation a display device, a printer, and/or the like.

The computer system 700 may further include (and/or be in communication with) one or more non-transitory storage devices 725, or computer-readable media, which can comprise, without limitation, local and/or network accessible storage. Generally speaking, the medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk-read/write (CD-R/W), DVD, and Blu-Ray Disc®. Such storage devices may be configured to implement any appropriate data stores, including without limitation, various file systems, database structures, and/or the like.

The computer system 700 can also include a communications interface 730, which can include wireless and wired communication technologies. Accordingly, the communications interface can include a modem, a network card (wireless or wired), an infrared communication device, a wireless communication device, and/or a chipset (such as a Bluetooth™ device, an IEEE 702.11 device, an IEEE 702.15.4 device, a WiFi device, a WiMax device, cellular communication facilities, UWB interface, etc.), and/or the like. The communications interface 730 can therefore permit the computer system 700 to be exchanged with other devices and components of a network.

In many embodiments, the computer system 700 will further comprise a working memory 735, which can include a RAM or ROM device, as described above. Software elements, shown as being located within the working memory 735, can include an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above, such as the methods described in relation to the methods described in relation to FIGS. 5 and 6, might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code. Thus, the invention can take the form of a computer program product accessible from a computer-usable or computer-readable medium providing program code for use by or in connection with a computer or any instruction execution system.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processing unit(s) 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Accordingly, computer software including instructions or code for performing the methodologies of the invention, as described herein, may be stored in one or more of the associated memory devices and, when ready to be utilized, loaded in part or in whole and executed by a CPU (e.g., processing unit 710). Such software could include, but is not limited to, firmware, resident software, microcode, and the like. Additionally or alternatively, portions of the methods described herein may be executed through specialized hardware.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of conducting a video image search and providing results thereof, the method comprising:
receiving, via a data communications network interface, an image;
extracting one or more of features of the image;
generating a representation of the image, based on the one or more features;
comparing, using a processing unit, the generated representation with a plurality of stored representations, wherein the plurality of stored representations includes stored representations of video frames from one or more videos;
determining a subset of the plurality of stored representations, the subset comprising stored representations with a degree of similarity to the generated representation above a certain threshold; and
sending, via the data communications network interface, information regarding the subset of the plurality of stored representations, wherein the information comprises, for each stored representation in the subset, a Universal Resource Locator (URL) related to a video corresponding to the stored representation.

2. The method of conducting the video image search and providing the results thereof, as recited in claim 1, wherein, for at least one stored representation in the subset, the URL related to the video corresponding to the at least one stored representation is configured to, when selected using an electronic device, cause the video to be streamed to the electronic device.

3. The method of conducting the video image search and providing the results thereof, as recited in claim 2, the URL is further configured to cause the video to begin the streaming at substantially the same point in the video at which the video frame of the corresponding stored representation appears.

4. The method of conducting the video image search and providing the results thereof, as recited in claim 1, further comprising creating the plurality of stored representations by:
obtaining the video frames from the one or more videos; and
for each video frame:
extracting one or more features of the video frame;
generating a representation of the video frame, based on the one or more features; and
storing the generated representation of the video frame.

5. The method of conducting the video image search and providing the results thereof, as recited in claim 4, wherein the obtaining the video frames occurs during a transcoding process of the one or more videos.

6. The method of conducting the video image search and providing the results thereof, as recited in claim 4, wherein the one or more videos are obtained from a web site.

7. The method of conducting the video image search and providing the results thereof, as recited in claim 1, wherein the image comprises:
a digital photograph of a display showing a video image; or
a screen capture of a displayed image.

8. The method of conducting the video image search and providing the results thereof, as recited in claim 1, wherein, for at least one stored representation in the subset, the URL related to the video corresponding to the at least one stored representation is configured to, when selected using an electronic device, cause the electronic device to display a web page having information regarding the video corresponding to the at least one stored representation.

9. The method of conducting the video image search and providing the results thereof, as recited in claim 8, wherein the information regarding the video includes metadata received as part of a video ingest process.

10. The method of conducting the video image search and providing the results thereof, as recited in claim 8, further including, in the web page, an advertisement based on a key word associated with the video frame of the at least one stored representation.

11. The method of conducting the video image search and providing the results thereof, as recited in claim 1, further comprising ranking each stored representation of the subset of the plurality of stored representations by a likelihood that each stored representation matches the generated representation.

12. The method of conducting the video image search and providing the results thereof, as recited in claim 11, wherein the ranking, for each stored representation, is based on analytics information of a corresponding video.

13. The method of conducting the video image search and providing the results thereof, as recited in claim 1, wherein determining the subset of the plurality of stored representations is based on an IP address from which the image is received.

14. A server for conducting a video image search and providing results thereof, the server comprising:
a communications interface;
a memory; and
a processing unit communicatively coupled with the communications interface and the memory, and configured to cause the server to:
receive, via the communications interface, an image;
extract one or more of features of the image;
generate a representation of the image, based on the one or more features;
compare the generated representation with a plurality of stored representations, wherein the plurality of stored representations includes stored representations of video frames from one or more videos;
determine a subset of the plurality of stored representations, the subset comprising stored representations with a degree of similarity to the generated representation above a certain threshold; and
send, via the communications interface, information regarding the subset of the plurality of stored representations, wherein the information comprises, for each stored representation in the subset, a Universal Resource Locator (URL) related to a video corresponding to the stored representation.

15. The server for conducting the video image search and providing the results thereof, as recited in claim 14, wherein the processing unit is further configured to cause the server to create the plurality of stored representations by:
obtaining the video frames from the one or more videos; and
for each video frame:
extracting one or more features of the video frame;
generating a representation of the video frame, based on the one or more features; and
storing the generated representation of the video frame.

16. A non-transitory computer-readable medium having instructions embedded thereon for conducting a video image search and providing results thereof, the instructions including computer code for performing functions including:
receiving an image;
extracting one or more of features of the image;
generating a representation of the image, based on the one or more features;
comparing the generated representation with a plurality of stored representations, wherein the plurality of stored representations includes stored representations of video frames from one or more videos;
determining a subset of the plurality of stored representations, the subset comprising stored representations with a degree of similarity to the generated representation above a certain threshold; and
sending information regarding the subset of the plurality of stored representations, wherein the information comprises, for each stored representation in the subset, a Universal Resource Locator (URL) related to a video corresponding to the stored representation.

17. The computer-readable medium as recited in claim 16, wherein the instructions further include computer code for creating the plurality of stored representations by:
obtaining the video frames from the one or more videos; and
for each video frame:
extracting one or more features of the video frame;
generating a representation of the video frame, based on the one or more features; and
storing the generated representation of the video frame.

18. The computer-readable medium as recited in claim 16, wherein the instructions further include computer code for creating a web page having information regarding the video corresponding to at least one stored representation of the subset.

19. The computer-readable medium as recited in claim 18, wherein the computer code for creating the web page further includes computer code for providing, in the web page, an advertisement based on a key word associated with the video frame of the at least one stored representation.

20. The computer-readable medium as recited in claim 16, wherein the instructions further include computer code for ranking each stored representation of the subset of the plurality of stored representations by a likelihood that each stored representation matches the generated representation.
